(19) United States
(12) Patent Application Publication
(10) Pub. No.: US 2013/0039568 A1
(43) Pub. Date: Feb. 14, 2013

(54) IMAGE PROCESSING APPARATUS, IMAGE PROCESSING METHOD, AND RECORDING MEDIUM

(71) Applicant: Shigeru FUTAWATARI, Tokyo (JP)

(72) Inventor: Shigeru FUTAWATARI, Tokyo (JP)

(73) Assignee: CASIO COMPUTER CO., LTD., Tokyo (JP)

(21) Appl. No.: 13/570,644

(22) Filed: Aug. 9, 2012

(30) Foreign Application Priority Data
Aug. 12, 2011 (JP) 2011-177139

(51) Int. Cl. G06K 9/36

(52) U.S. Cl. 382/154

(57) ABSTRACT

An image processing apparatus includes: a separation unit that separates each of the left image and the right image into a background area and a foreground area, regarding a first three-dimensional image data acquired by a acquisition unit; a background image generation unit that generates data of a background image by executing image processing on at least one of the background area of the left image and the background area of the right image separated by the separation unit; and a three-dimensional image data generation unit that generates second three-dimensional image data composed of two images having a parallax between a left image and a right image, by combining data of the background image generated by the background image generation unit and data of foreground images regarding the foreground area separated from each of the left image and the right image by the separation unit.

This application is based on and claims the benefit of priority from Japanese Patent Application No. 2011-177139, filed on 12 Aug. 2011, the content of which is incorporated herein by reference.

### BACKGROUND OF THE INVENTION

1. Field of the Invention

The present Invention relates to an image processing apparatus, an image processing method, and a recording medium.

2. Related Art

Conventionally, there is a technology for three-dimensionally displaying an image (hereinafter referred to as a “3D (three-dimensional) image”) based on a two-dimensionally displayed image. As a technology for displaying a 3D image, for example, there is a technology for displaying a 3D image by preparing two different images having a parallax, by utilizing a characteristic of a human to perceive depth of an image based on difference of positions in the images (a parallax) viewed by a right eye and a left eye (Japanese Unexamined Patent Application, Publication No. H8-30806). In the technology disclosed in the above patent document, in which a 3D image is displayed by using two different images having a parallax, the parallax is larger for an object in the foreground of the 3D image, and the parallax is smaller for an object in the background of the 3D image.

In recent years, it has been required to arrange an image for effectively displaying the image, and it has also been required to arrange a 3D image in various ways for providing visual effects.

### SUMMARY OF THE INVENTION

An object of the present invention is to provide an image processing apparatus and an image processing method as well as a program, all of which are capable of generating 3D image data that allows various arrangements.

An image processing apparatus according to one aspect of the present invention includes: an acquisition unit that acquires first three-dimensional image data composed of two images having a parallax between a left image and a right image; a separation unit that separates each of the left image and the right image into a background area and a foreground area, regarding the first three-dimensional image data acquired by the acquisition unit; a background image generation unit that generates data of a background image by executing image processing on at least one of the background area of the left image and the background area of the right image separated by the separation unit; and a three-dimensional image data generation unit that generates second three-dimensional image data composed of two images having a parallax between a left image and a right image, by combining data of the background image generated by the background image generation unit and data of foreground images regarding the foreground area separated from each of the left image and the right image by the separation unit.

An image processing method according to one aspect of the present invention is an image processing method executed by an image processing apparatus, and the method includes: an acquisition step of acquiring first three-dimensional image data having a parallax between a left image and a right image; a separating step of separating each of the left image and the right image into a background area and a foreground area, regarding the first three-dimensional image data acquired in the acquiring step; a background image generating step of generating data of a background image by executing image processing on at least one of the background area of the left image and the background area of the right image separated in the separating step; and a three-dimensional image data generating step of generating second three-dimensional image data composed of two images having a parallax between a left image and a right image, by combining data of the background image generated in the background image generating step and data of foreground images regarding the foreground area separated from each of the left image and the right image in the separation step.

A recording medium according to one aspect of the present invention is a recording medium including a program for causing a computer to execute: an acquisition step of acquiring first three-dimensional image data composed of two images having a parallax between a left image and a right image; a separating step of separating each of the left image and the right image into a background area and a foreground area, regarding the first three-dimensional image data acquired in the acquiring step; a background image generating step of generating data of a background image by executing image processing on at least one of the background area of the left image and the background area of the right image separated in the separating step; and a three-dimensional image data generating step of generating second three-dimensional image data composed of two images having a parallax between a left image and a right image, by combining data of the background image generated in the background image generating step and data of foreground images regarding the foreground area separated from each of the left image and the right image in the separation step.

### BRIEF DESCRIPTION OF THE DRAWINGS

FIGS. 1A, 1B and 1C are schematic diagrams for illustrating generation of data of a painterly-backgrounded 3D image;

FIG. 2 is a block diagram showing a hardware configuration of an image processing apparatus according to an embodiment of the present invention;

FIG. 3 is a functional block diagram showing a functional configuration for executing painterly-backgrounded 3D image generation processing, among functional configurations of the image processing apparatus in FIG. 2;

FIG. 4 is a functional block diagram showing a detailed functional configuration of a painterly background image generation unit in FIG. 3;

FIG. 5 is a flowchart for illustrating a flow of painterly-backgrounded 3D image generation processing, which is executed by the image processing apparatus in FIG. 2 having the functional configuration in FIG. 3; and

FIG. 6 is a flowchart for illustrating a flow of painterly background image generation processing, which is executed by the image processing apparatus in FIG. 2 having the functional configuration in FIG. 4.

### DETAILED DESCRIPTION OF THE INVENTION

Before describing an embodiment of the present invention, an overview of the present invention is hereinafter described for the purpose of facilitating the understanding thereof.

An image processing apparatus according to the present invention is an apparatus capable of displaying a painterly-backgrounded 3D image.

Here, the “painterly-backgrounded 3D image” refers to an image, in which a portion corresponding to the background (a background portion) is displayed in a painterly manner (in a manner like a watercolor painting in the present embodiment), and a portion other than the background portion (a foreground portion) is three-dimensionally displayed as if protruding forward.

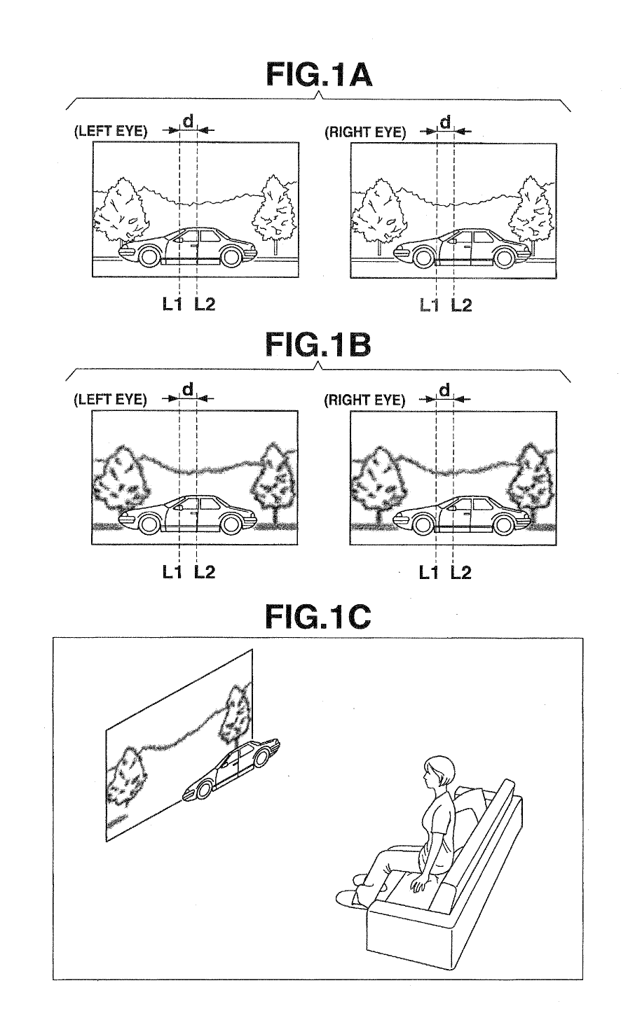

FIGS. 1A, 1B and 1C are schematic diagrams for illustrating generation of data of a painterly-backgrounded 3D image. More specifically, FIG. 1A is a schematic diagram showing examples of an image for the left eye and an image for the right eye for implementing 3D image displaying. FIG. 1B is a schematic diagram showing examples of an image for a left eye and an image for a right eye after executing painterly conversion processing on background areas of the image for the left eye and the image for the right eye, respectively, of FIG. 1A. FIG. 1C is a schematic diagram showing an example of a 3D image that is displayed by using the image for the left eye and the image for the right eye in FIG. 1B.

The “image for the left eye” is an image viewed by the left eye of a person, in which an identical subject is deviated to the left as compared to that in the image for the right eye. The “image for the right eye” is an image viewed by the right eye of the person, in which the identical subject is deviated to the right as compared to that in the image for the left eye.

In other words, the image for the left eye is viewed by a retina of the left eye of the person, and the image for the right eye is viewed by a retina of the right eye of the person. For example, in FIGS. 1A and 1B, lines L1 and L2 are drawn at positions separated by a distance d in a horizontal direction, and the positions of the lines L1 and L2 are common to those in the image for the left eye and the image for the right eye. However, a side mirror of a car in the foreground is positioned in the line L1 in the image for the left eye, whereas the side mirror of the car in the foreground is positioned in the line L2 in the image for the right eye, the line L2 being deviated from the line L1 by the distance d. Such a deviated distance d is a parallax, and the presence of the parallax causes the human brain to recognize the car in the foreground as being three-dimensionally displayed as if protruding forward.

In a 3D image, the degree of protruding forward is increased as the parallax is increased. In other words, a subject with a large parallax is displayed in the foreground as if protruding forward, and a subject with a small parallax is displayed in the background with depth as if existing backward.

It should be noted that a subject such as a car is captured as an image, as an example of a 3D image for illustrating the present embodiment. More specifically, the car is located on the front side in the central portion of the image, and a tree is located on the back side of the car. In other words, the image has a composition, in which the car exists against the background of the tree.

The image processing apparatus according to the present invention executes image processing on only data of the background areas of the image for the left eye and the image for the right eye. In other words, the image processing apparatus according to the present invention generates each data of the image for the left eye and the image for the right eye, in which the image processing is executed on the background areas, whereas the image processing is not executed on the foreground areas.

In the embodiment to be described below with reference to FIGS. 1 to 6, the painterly conversion processing is executed as image processing to provide, for example, a painterly image.

As a result, as shown in FIG. 1B, each data of the image for the left eye and the image for the right eye is generated, in which the background area (the area in which the subject is the tree in this example) is rendered to be painterly, and the foreground area (the area in which the subject is the car in this example) remains original.

It should be noted that the image for the left eye and the image for the right eye, in which the background area is rendered to be painterly, and the foreground area remains original, are hereinafter referred to as a painterly background image for the left eye and a painterly background image for the right eye, respectively. Moreover, each data of the painterly background image for the left eye and the painterly background image for the right eye is collectively referred to as a “painterly-backgrounded 3D image data” as appropriate.

In this way, in the image processing for generating each data (painterly-backgrounded 3D image data) of the painterly background image for the left eye and the painterly background image for the right eye, the processing is executed on only the background areas of the image for the left eye and the image for the right eye. Therefore, in each of the image for the left eye and the image for the right eye, the background area needs to be distinguished from the foreground area other than the background area. Although such a technique for distinguishing the background area from the foreground area is not limited in particular, it is possible to employ a technique of utilizing a characteristic of a parallax between the image for the left eye and the image for the right eye, in which the parallax is large (i.e. the deviation is large) in the foreground, and the parallax is small in the background (i.e. the deviation in the background is smaller than the deviation in the foreground). More specifically, it is possible to employ a technique, in which an area of an identical subject with at least a certain parallax (the area of the identical subject with at least certain deviation) between the image for the left eye and the image for the right eye is treated as a foreground, and an area other than such a foreground is treated as a background.

The image processing apparatus according to the present invention displays each of the painterly background image for the left eye and the painterly background image for the right eye. As a result, the eyes of the user being a viewer recognize the images as if a painterly-backgrounded 3D image is displayed. In other words, as shown in FIG. 1C, the eyes of the user view a painterly image, such that the foreground area (the area in which the subject is the car in the example in FIG. 1C) is three-dimensionally viewed as if protruding forward, and the background area (the area in which the subject is the tree in the example in FIG. 1C) is viewed as if existing in depth without protruding forward. In this way, what the user can enjoy is not a conventional simple 3D image, but is a painterly-backgrounded 3D image with a higher level of artistry, in which the background area is rendered to be painterly.

With reference to the drawings, descriptions are hereinafter provided for the image processing apparatus capable of generating each data (painterly-backgrounded 3D image data) of such a painterly background image for the left eye and such a painterly background image for the right eye. In other words, an embodiment of the image processing apparatus of the present invention is described.

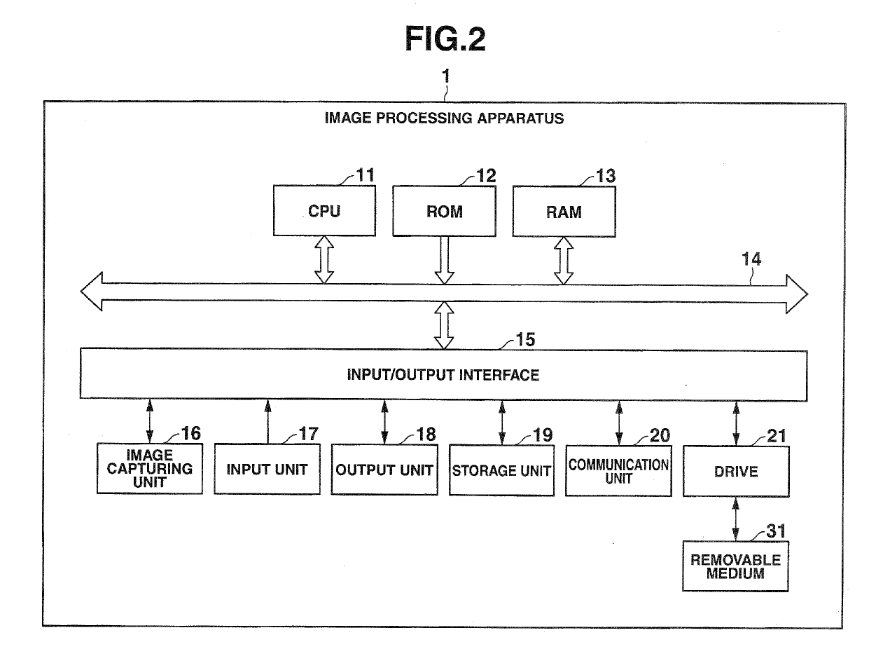

FIG. 2 is a block diagram showing a hardware configuration of an image processing apparatus 1 according to an embodiment of the present invention.

The image processing apparatus 1 is configured as, for example, a digital camera.

The image processing apparatus 1 includes a CPU (Central Processing Unit) 11, ROM (Read Only Memory) 12, RAM (Random Access Memory) 13, a bus 14, an input/output interface 15, an image capturing unit 16, an input unit 17, an output unit 18, a storage unit 19, a communication unit 20, and a drive 21.

The CPU 11 executes various types of processing according to programs that are recorded in the ROM 12 or programs that are loaded from the storage unit 19 to the RAM 13.

The RAM 13 also stores data and the like necessary for the CPU 11 to execute the various types of processing, as appropriate.

The CPU 11, the ROM 12 and the RAM 13 are connected to one another via the bus 14. The bus 14 is also connected with the input/output interface 15. The input/output interface 15 is connected to the image capturing unit 16, the input unit 17, the output unit 18, the storage unit 19, the communication unit 20, and the drive 21.

The image capturing unit 16 includes an optical lens unit and an image sensor, which are not illustrated.

In order to capture an image of a subject, the optical lens unit is configured by a lens for condensing light such as, for example, a focus lens and a zoom lens.

The focus lens is a lens for forming an image of a subject on a light receiving surface of the image sensor. The zoom lens is a lens for freely changing a focal length within a certain range.

The optical lens unit also includes peripheral circuits for adjusting configuration parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time period, and sequentially supplies the image signal as an analog signal to the AFE.

The AFE executes various kinds of signal processing such as A/D (Analog/Digital) conversion processing on the analog image signal. The various kinds of signal processing generate a digital signal, which is output as an output signal from the image capturing unit 16.

Such an output signal from the image capturing unit 16 is hereinafter referred to as “data of a captured image”. The data of the captured image is supplied to the CPU 11 as appropriate.

The input unit 17 is configured by various types of buttons and the like, with which various information is input in accordance with instruction operations by the user. The output unit 18 is configured by a display, a speaker and the like, and outputs images and sound.

The storage unit 19 is configured by DRAM (Dynamic Random Access Memory) or the like, and stores data of various images.

The communication unit 20 controls communication with other devices (not illustrated) via a network including the Internet.

A removable medium 31 composed of a magnetic disk, an optical disk, a magneto-optical disk, semiconductor memory or the like is mounted in the drive 21, as appropriate. Programs read via the drive 21 from the removable medium 31 are installed in the storage unit 19 as necessary. In addition, similarly to the storage unit 19, the removable medium 31 can also store various kinds of data such as image data stored in the storage unit 19.

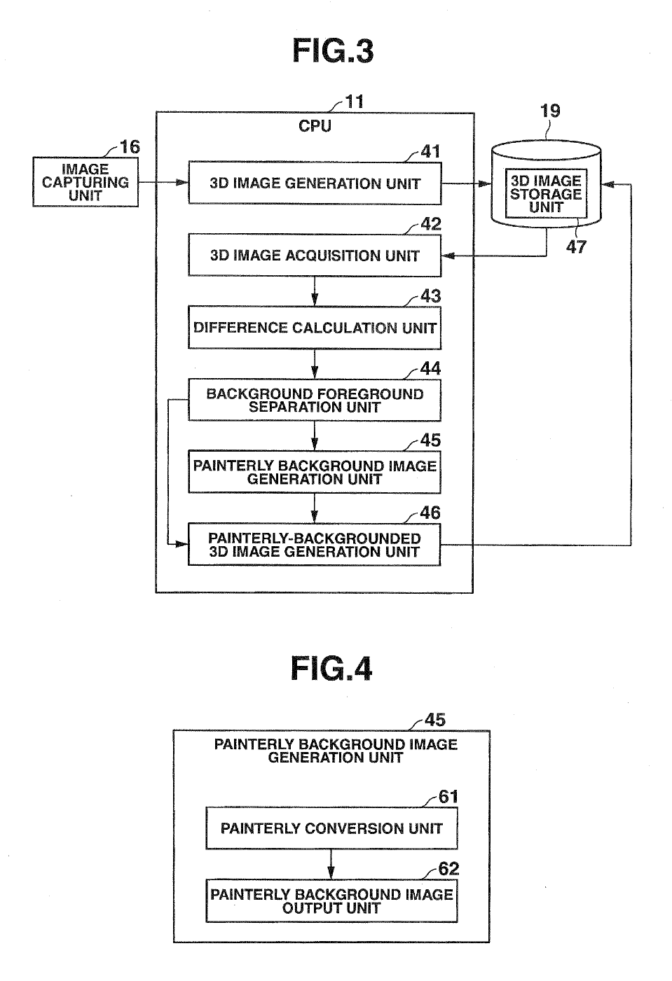

FIG. 3 is a functional block diagram showing a functional configuration for executing painterly-backgrounded 3D image generation processing, among functional configurations of such an image processing apparatus 1.

The painterly-backgrounded 3D image generation processing refers to a sequence of processing of generating each data (painterly-backgrounded 3D image data) of a painterly background image for the left eye and a painterly background image for the right eye, from each data of the image for the left eye and the image for the right eye for conventional 3D image displaying (hereinafter also referred to as “3D image data” as appropriate).

It should be noted that, in the present embodiment, the painterly-backgrounded 3D image generation processing also includes processing of generating each data (3D image data) of the image for the left eye and the image for the right eye for conventional 3D image displaying from data of a captured image acquired by the image capturing unit 16. However, such conventional processing is not essential for the painterly-backgrounded 3D image generation processing, and is not necessary in a case such as, for example, a case in which the image capturing unit 16 itself is equipped with a stereoscopic lens, or is capable of communicating with external devices, since it is possible to obtain each data of the image for the left eye and the image for the right eye, which are already generated.

In a case in which the painterly-backgrounded 3D image generation processing is executed, a 3D image generation unit 41, a 3D image acquisition unit 42, a difference calculation unit 43, a background foreground separation unit 44, a painterly background image generation unit 45, and a painterly-backgrounded 3D image generation unit 46 function in the CPU 11 of the image processing apparatus 1.

In this case, a 3D image storage unit 47 that is provided as an area of the storage unit 19 is used.

The 3D image generation unit 41 generates each data (3D image data) of the image for the left eye and the image for the right eye for conventional 3D image displaying, from data of an acquired image. In the present embodiment, the 3D image generation unit 41 generates each data of two different images including the image for the left eye and the image for the right eye with a parallax as shown in FIG. 1A, from data of an image captured through the image capturing unit 16.

The 3D image storage unit 47 stores each data (3D image data) of the image for the left eye and the image for the right eye generated by the 3D image generation unit 41.

The 3D image acquisition unit 42 acquires each data (3D image data) of the image for the left eye and the image for the right eye for conventional 3D image displaying, from the 3D image storage unit 47.

The difference calculation unit 43 calculates differential values regarding each data (3D image data) of the image for the left eye and the image for the right eye acquired by the 3D image acquisition unit 42. Based on the differential values thus calculated, the difference calculation unit 43 calculates a parallax between each corresponding area or pixel in the image for the left eye and the image for the right eye.

Based on the parallax of each area calculated from the differential values in the image for the left eye and the image for the right eye, the background foreground separation unit 44 separates each data of the image for the left eye and the image for the right eye into each data of a foreground image and a background image.

Here, the foreground image refers to an image, in which the resolution is common to the image for the left eye and the image for the right eye, the foreground area has original pixel values (the foreground area remains unchanged), and the other area has a certain pixel value; in other words, only the foreground area exists, and the other area has a uniform color such as black.

On the other hand, the background image refers to an image, in which the resolution is common to the image for the left eye and the image for the right eye, the background area has original pixel values (the background area remains unchanged), and the other area has a certain pixel value; in other words, only the background area exists, and the other area has a uniform color such as black.

Each data of the foreground images in the image for the left eye and the image for the right eye is supplied to the painterly-backgrounded 3D image generation unit 46. On the other hand, each data of the background images in the image for the left eye and the image for the right eye is supplied to the painterly background image generation unit 45.

The painterly background image generation unit 45 executes painterly conversion processing on each data of the background images in the image for the left eye and the image for the right eye supplied from the background foreground separation unit 44. Such a sequence of processing is hereinafter referred to as “painterly background image generation processing”. In addition, the data of the background image obtained as a result of the painterly background image generation processing is hereinafter referred to as “data of painterly background images”.

Each data of the painterly background images in the image for the left eye and the image for the right eye is supplied from the painterly background image generation unit 45 to the painterly-backgrounded 3D image generation unit 46.

For each of the image for the left eye and the image for the right eye, the painterly-backgrounded 3D image generation unit 46 combines the data of the painterly background images generated by the painterly background image generation unit 45 and the data of the foreground images separated by the background foreground separation unit 44, thereby generating each data (painterly-backgrounded 3D image data) of the painterly background image for the left eye and the painterly background image for the right eye, as shown in FIG. 1B.

Each data (painterly-backgrounded 3D image data) of the painterly background image for the left eye and the painterly background image for the right eye thus generated are stored in the 3D image storage unit 47.

FIG. 4 is a functional block diagram showing a detailed functional configuration of the painterly background image generation unit 45 in FIG. 3.

The painterly background image generation unit 45 includes a painterly conversion unit 61 and a painterly background image output unit 62.

The painterly conversion unit 61 executes painterly conversion processing on each data of the background images in the image for the left eye and the image for the right eye supplied from the background foreground separation unit 44, thereby generating each data of the background images converted into painterly images, i.e. each data of the painterly background images. Here, the painterly conversion processing executed by the painterly conversion unit 61 is not limited in particular, and it is possible to employ a manner like, for example, a watercolor painting, an oil painting, a pastel drawing, a pencil sketch or the like.

The painterly background image output unit 62 outputs each data generated by the painterly conversion unit 61, i.e. outputs each data of the painterly background images in the image for the left eye and the image for the right eye, to the painterly-backgrounded 3D image generation unit 46.

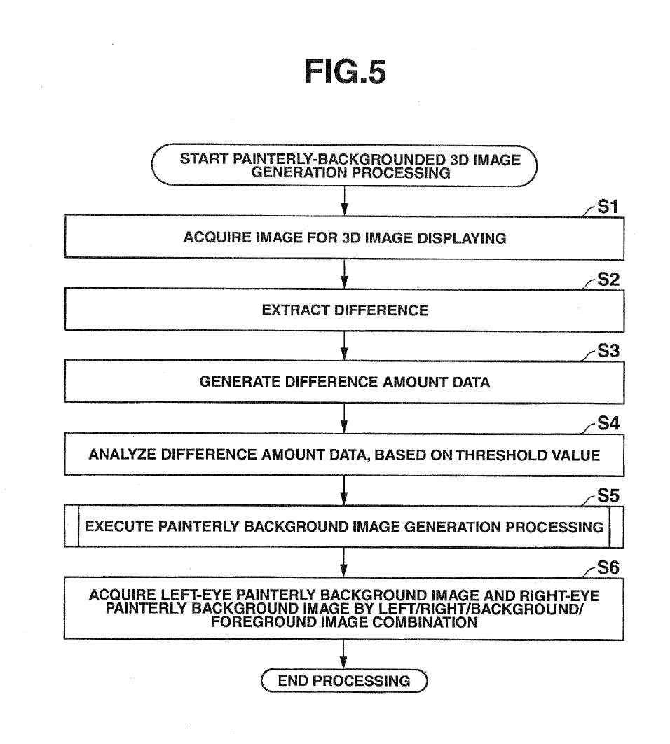

FIG. 5 is a flowchart for illustrating a flow of the painterly-backgrounded 3D image generation processing, which is executed by the image processing apparatus 1 in FIG. 2 having the functional configuration in FIG. 3.

For example, when a user presses down a shutter button (a component of the input unit 17), data of a captured image captured by the image capturing unit 16 is supplied to the 3D image generation unit 41. From the data of the captured image, the 3D image generation unit 41 generates each data (3D image data) of the image for the left eye and the image for the right eye for conventional 3D image displaying, and stores the data into the 3D image storage unit 47.

In a state where each data (3D image data) of the image for the left eye and the image for the right eye for conventional 3D image displaying is stored in the 3D image storage unit 47 in this manner, when a predetermined operation of the input unit 17 is performed by the user, the painterly-backgrounded 3D image generation processing is initiated.

In Step S1, the 3D image acquisition unit 42 acquires each data of the image for the left eye and the image for the right eye for conventional 3D image displaying as shown in FIG. 1A (3D image data that is described as “3D image” in FIG. 5).

In Step S2, regarding each data (3D image data) of the image for the left eye and the image for the right eye, the difference calculation unit 43 extracts difference between each corresponding area or pixel, thereby calculating a parallax of each area. For example, in a case in which the processing is executed on each data of the image for the left eye and the image for the right eye in FIG. 1A, the difference (an amount of deviation) is extracted for each area of the subject (the car or the tree), and each parallax is calculated.

In Step S3, the difference calculation unit 43 generates difference amount data indicating a parallax level of each area in the image for the left eye and the image for the right eye. The difference amount data is data such as, for example, the number of pixels or the like indicating how many pixels are deviated in the image.

In Step S4, based on a threshold value that should be compared with the difference amount data (a parallax level indicated by the data), the background foreground separation unit 44 analyzes the difference amount data for each area of the image for the left eye and the image for the right eye. In other words, the background foreground separation unit 44 sequentially executes processing on each area of the left eye and the image for the right eye, and compares the difference amount data (a parallax level indicated by such data) with the threshold value of each area, thereby analyzing whether the area is a background area or a foreground area. In addition, based on results of analyzing each area, the background foreground separation unit 44 separates each data of the image for the left eye and the image for the right eye into each data of the foreground image and the background image.

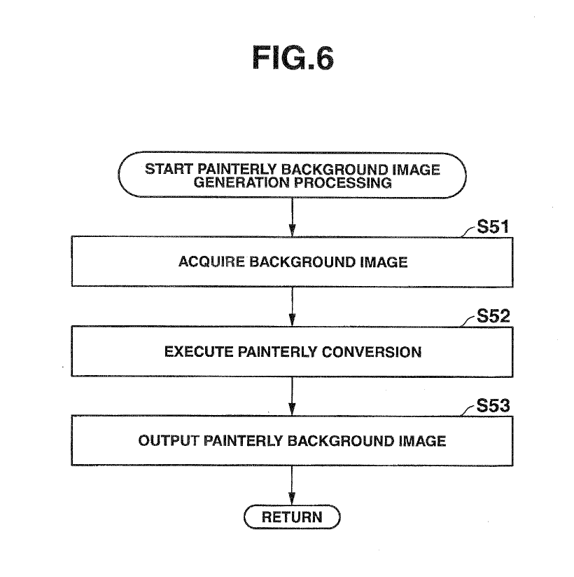

In Step S5, the painterly background image generation unit 45 executes the painterly background image generation processing on each data of the foreground image and the background image in each of the image for the left eye and the image for the right eye. As a result, each data of the painterly foreground image and the painterly background image in each of the image for the left eye and the image for the right eye is obtained. It should be noted that the painterly background image generation processing will be described later in detail with reference to a flowchart in FIG. 6.

In Step S6, the painterly-backgrounded 3D image generation unit 46 combines each data of the painterly background image and the foreground image (left/right/background/foreground image combination as described in FIG. 5) for each of the image for the left eye and the image for the right eye, thereby generating each data (painterly-backgrounded 3D image data) of the painterly background image for the left eye and the painterly background image for the right eye as shown in FIG. 1B.

When each data (painterly-backgrounded 3D image data) of the painterly background image for the left eye and the painterly background image for the right eye thus generated is stored into the 3D image storage unit 47, the painterly-backgrounded 3D image generation processing is terminated.

Next, a flow of the painterly background image generation processing is described with reference to FIG. 6.

FIG. 6 is a flowchart for illustrating a detailed flow of the painterly background image generation processing in Step S5 shown in FIG. 5.

In Step S51, the painterly conversion unit 61 acquires each data of the background images in the image for the left eye and the image for the right eye supplied from the background foreground separation unit 44.

In Step 52, the painterly conversion unit 61 executes the painterly conversion processing on each data of the background images obtained in the processing in Step 51, thereby generating each data of the background images converted into painterly images, i.e. each data of the painterly background images.

In Step S53, the painterly background image output unit 62 outputs each data generated in the processing in Step S52, i.e. outputs each data of the painterly background images in the image for the left eye and the image for the right eye, to the painterly-backgrounded 3D image generation unit 46. It should be noted that the image to be output may be any one of the background images in the image for the left eye and the image for the right eye, on which the painterly conversion processing was executed. In other words, any one of the background image for the left eye and the background image for the right eye may be output as a painterly background image for the left eye and the right eye, which may also be an identical painterly background image.

As a result, the painterly background image generation processing is terminated, i.e. the processing in Step S5 shown in FIG. 5 is terminated, and the processing advances to Step S6.

The image processing apparatus 1 configured as above includes the 3D image acquisition unit 42, the background foreground separation unit 44, the painterly background image generation unit 45, and the painterly-backgrounded 3D image generation unit 46.

The 3D image acquisition unit 42 acquires 3D image data having a parallax between the left image and the right image.

Regarding the 3D image data acquired by the 3D image acquisition unit 42, the background foreground separation unit 44 separates each of the left image and the right image into a background area and a foreground area.

The painterly background image generation unit 45 executes the painterly conversion processing on the background areas of the left image and the right image separated by the background foreground separation unit 44, thereby generating data of at least one painterly background image.

For each of the left image and the right image, the painterly-backgrounded 3D image generation unit 46 combines the data of the painterly background image generated by the painterly background image generation unit 45 and the data of the foreground image of the foreground area separated by the background foreground separation unit 44, thereby generating painterly-backgrounded 3D image data.

The image processing apparatus 1 as thus constituted can generate painterly-backgrounded 3D image data, in which the foreground is three-dimensionally displayed. Therefore, a user can be provided with various image arrangements for achieving visual effects in a 3D image.

Moreover, the image processing apparatus 1 further includes the difference calculation unit 43 that calculates difference between each corresponding area in the left image and the right image of the 3D image data.

Based on the difference calculated by the difference calculation unit 43, the background foreground separation unit 44 separates each of the left image and the right image of the 3D image data into a background area and a foreground area.

With the image processing apparatus 1 as thus constituted, an image is separated into a background area and a foreground area by utilizing a characteristic of a 3D image in which a parallax of the foreground area is different from a parallax of the background area; therefore, the image can be reliably separated into the background area and the foreground area.

In addition, the image processing apparatus 1 includes the 3D image generation unit 41.

The 3D image generation unit 41 generates 3D image data having a parallax between the left image and the right image, from data of a single image acquired.

With the image processing apparatus 1 as thus constituted, 3D image data can be generated from a single image; therefore, painterly-backgrounded 3D image data can be generated even if an acquired image is not a 3D image.

It should be noted that the present invention is not limited to the embodiment described above, and any modifications and improvements thereto within the scope that can realize the object of the present invention are included in the present invention.

Although a 3D image is composed of a static image in the embodiment described above, the present invention is not limited thereto, and a 3D image may be composed of a dynamic image. In this case, by executing the painterly-backgrounded 3D image generation processing on each static image composing a dynamic image, similar displaying is possible for the dynamic image as well.

Furthermore, although the painterly conversion processing is executed on a background image in the above-mentioned embodiment, the present invention is not limited thereto, and the painterly conversion processing may be executed on a foreground image.

Moreover, although difference between each corresponding area or pixel is extracted for each data (3D image data) of the image for the left eye and the image for the right eye acquired in the abovementioned embodiment, difference may not be extracted in a case in which information indicating difference, information indicating a parallax, or information indicating a foreground area and a background area is added to the 3D image data in advance.

In addition, although a background portion is made painterly (for example, in a manner like an oil painting) in the embodiment described above, the present invention is not limited thereto, and a special effect such as, for example, an embossing effect may be provided to a background area by using various types of image processing.

Furthermore, although a digital camera has been described in the embodiment as an example of the image processing apparatus 1, to which the present invention is applied, the present invention is not limited thereto in particular.

The present invention can be generally applied to any electronic device having a function of executing painterly-backgrounded 3D image generation processing. More specifically, for example, the present invention can be applied to a laptop personal computer, a printer, a television, a video camera, a portable navigation device, a cell phone device, a portable game device, and the like.

The sequence of processing described above can be executed by hardware, and can also be executed by software.

In other words, the hardware configuration shown in FIG. 3 is merely an illustrative example, and the present invention is not limited thereto in particular. More specifically, the types of functional blocks employed for implementing the abovementioned functions are not limited to the example in FIG. 3 in particular, so long as the image processing apparatus 1 includes a function enabling the abovementioned sequence of processing to be executed in its entirety.

A single functional block may be configured by a single piece of hardware, a single installation of software, or any combination thereof.

In a case in which a sequence of processing is executed by software, a program configuring the software is installed from a network or a storage medium into a computer or the like.

The computer may be a computer embedded in dedicated hardware. Alternatively, the computer may be a computer capable of executing various functions by installing various programs, for example, a general-purpose personal computer.

The storage medium containing such a program can not only be constituted by the removable medium 31 shown in FIG. 2 distributed separately from the device main body for supplying the program to a user, but can also be constituted by a storage medium or the like supplied to the user in a state incorporated in the device main body in advance. The removable medium 31 is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), or the like, for example. The magnetic optical disk is composed of an MD (Mini-Disk) or the like. The storage medium supplied to the user in a state incorporated in the device main body in advance may include the ROM 12 shown in FIG. 2, a hard disk included in the storage unit 19 shown in FIG. 2, or the like in which the program is recorded, for example.

It should be noted that, in the present specification, the steps describing the program recorded in the storage medium include not only the processing executed in a time series following this order, but also processing executed in parallel or individually, which is not necessarily executed in a time series.

Moreover, in the present specification, terminologies describing a system refer to a whole apparatus configured with a plurality of devices, a plurality of means and the like.

Although some embodiments of the present invention have been described above, such embodiments are merely exemplification, and are not intended to limit the technical scope of the present invention. The present invention can be implemented in other various embodiments, and in addition, modification such as omission or substitution is possible without departing from the scope of the present invention. The embodiments and modification are included in the scope and summary of the invention described in the present specification and the like, and are included in the invention recited in the claims as well as the scope equivalent thereto.

What is claimed is:

1. An image processing apparatus, comprising:
an acquisition unit that acquires first three-dimensional image data composed of two images having a parallax between a left image and a right image;
a separation unit that separates each of the left image and the right image into a background area and a foreground area, regarding the first three-dimensional image data acquired by the acquisition unit;
a background image generation unit that generates data of a background image by executing image processing on at least one of the background area of the left image and the background area of the right image separated by the separation unit; and
a three-dimensional image data generation unit that generates second three-dimensional image data composed of two images having a parallax between a left image and a right image, by combining data of the background image generated by the background image generation unit and data of foreground images regarding the foreground area separated from each of the left image and the right image by the separation unit.

2. The image processing apparatus according to claim 1, further comprising a calculation unit that calculates difference between each corresponding area in the left image and the right image of the first three-dimensional image data,
wherein the separation unit separates each of the left image and the right image of the first three-dimensional image data into a background area and a foreground area, based on the difference calculated by the calculation unit.

3. The image processing apparatus according to claim 1, wherein the background image generation unit executes painterly image conversion processing as the image processing.

4. The image processing apparatus according to claim 1, further comprising a generation unit that generates the first three-dimensional image data from data of a single image acquired.

5. An image processing method executed by an image processing apparatus, the method comprising:
an acquisition step of acquiring first three-dimensional image data having a parallax between a left image and a right image;
a separating step of separating each of the left image and the right image into a background area and a foreground area, regarding the first three-dimensional image data acquired in the acquiring step;
a background image generating step of generating data of a background image by executing image processing on at least one of the background area of the left image and the background area of the right image separated in the separating step; and
a three-dimensional image data generating step of generating second three-dimensional image data composed of two images having a parallax between a left image and a right image, by combining data of the background image generated in the background image generating step and data of foreground images regarding the foreground area separated from each of the left image and the right image in the separation step.

6. A recording medium including a program for causing a computer to execute:
an acquisition step of acquiring first three-dimensional image data composed of two images having a parallax between a left image and a right image;
a separating step of separating each of the left image and the right image into a background area and a foreground area, regarding the first three-dimensional image data acquired in the acquiring step;
a background image generating step of generating data of a background image by executing image processing on at least one of the background area of the left image and the background area of the right image separated in the separating step; and
a three-dimensional image data generating step of generating second three-dimensional image data composed of two images having a parallax between a left image and a right image, by combining data of the background image generated in the background image generating step and data of foreground images regarding the foreground area separated from each of the left image and the right image in the separation step.
